(19) United States
(12) Patent Application Publication
(10) Pub. No.: US 2008/0272590 A1
(43) Pub. Date: Nov. 6, 2008

(54) Reusable fitting, connector assembly and kit

(76) Inventors: Joseph D. Howard, New Ipswich, NH (US); Kevin J. Mitchell, Laconia, NH (US)

Correspondence Address: Lawson & Persson, P.C., P.O. Box 712, Laconia, NH, 03247, US

(21) Appl. No.: 11/799,607

(22) Filed: May 2, 2007

(51) Int. Cl. F16L 33/00

(52) U.S. Cl. 285/247; 285/386

(57) ABSTRACT

A reusable fitting, connector assembly and kit. The reusable fitting includes a barb portion, a threaded portion, a tightening portion, a connector portion and a substantially smooth cylindrical bore extending through the barb portion, threaded portion, tightening portion and connector portion. The tightening portion is disposed proximate to the threaded portion and includes least two parallel tightening surfaces. The connector assembly includes the fitting, a nut and a crimp sleeve. The kit includes the connector assembly and at least one wrench.

### FIELD OF THE INVENTION

The present invention relates to the field of fittings for connecting sections of flexible hose and, in particular, to reusable sanitary fittings for connecting sections of flexible hose used in sanitary applications.

### BACKGROUND OF THE INVENTION

Product contamination is a major concern of producers of a large number of products, including producers of food products, medical products, pharmaceuticals, biotechnology products, electronics, and personal care products. For this reason, the equipment used to manufacture these products must be designed to limit points where such contamination is likely to occur and, once it is put into use, the equipment must be frequently cleaned and sanitized.

The transfer of fluid through flexible hose or tubing is widely used in a number of different processes. Flexible hose is preferred over stainless steel in many applications due to its lower cost, ease of installation, and the ability to easily modify the piping after installation. One problem with the use of flexible tubing is the need to connect the tubing to the source of gaseous or liquid fluid, the delivery site of the fluid, or to another flexible tubing. At the ends of the flexible tubing, it is necessary to provide a secure and leak proof connections. Although these requirements are necessary in all environments using flexible tubing, it is critical in the fields, such as medical, food products, medical products, pharmaceuticals, biotechnology products, where contamination is such a concern.

There are a number of different types of sanitary connectors currently on the market for joining flexible hose and tubing. Most of these connectors are single use connectors that are permanently attached to the hose or tubing. Thus, if the hose or tubing needs to be removed, a new fitting must be purchased. Given the relatively high cost of such fittings, there was a need for a reusable sanitary fitting for use with such hoses and tubing.

The three-piece reusable sanitary tri-clamp style connector assembly shown in FIG. 1 was developed in response to this need. These connector assemblies typically include a stainless steel fitting having a threaded portion and a barb portion, a crimp sleeve dimensioned to fit around the hose, and a nut having a tapered portion dimensioned to interfere with the crimp sleeve and a threaded portion dimensioned to mate with the treaded portion of the fitting. In use, the hose is cut to length, the nut is slid onto the hose with the threads facing out, and the crimp sleeve is slid onto the hose so that the end of the hose is just below the end of the crimp sleeve. The barb portion of the fitting is then inserted into the hose until the barb is at its maximum depth and the crimp sleeve rests inside a groove on the back of the fitting. The nut is then threaded onto the threaded portion of the fitting and tightened. Because the nut has a tapered portion that is dimensioned to interfere with the crimp sleeve, the tightening of the nut onto the fitting acts to force the crimp sleeve inward against the hose, which causes the hose to be sealed against the barb portion of the fitting. This seal, coupled with the attachment of the nut to the fitting, effectively joins the hose to the fitting.

Although the three-piece reusable tri-clamp style connector assembly described above is effective at joining lengths of flexible hose, it is not without its drawbacks. First, these three-piece reusable tri-clamp style fittings do not include any easy means for holding the fitting in a stationary position while the nut is being tightened. Accordingly, it is not uncommon for tools, such as vice grips or large pliers to be utilized. Such tools can lead to a marring of the surface of the fitting, which is unacceptable in sanitary applications and may cause the fitting to need to be replaced. Because of this problem, specialized tools are often used to secure the fittings. These tools are often cumbersome to use on a jobsite and the failure to have such a tool results in the fitting not being able to be effectively secured.

Another drawback inherent in conventional three-piece reusable tri-clamp style connector assemblies is the inability of the assembler to determine when the nut is sufficiently tightened onto the fitting. Accordingly, there is often great variation in how much the nuts are tightened, with some being insufficiently tightened and others over tightened to the point where the crimp sleeve causes damage to the hose. Thus, it is not uncommon for users of these fittings to require that the manufacturer attach the assembly to the hose or tubing, significantly increasing the time and cost involved. Further, in cases where the users do attach the assembly themselves, such uses are typically in lower pressure applications where the risk of under-tightening is low.

Therefore, there is a need for an improved three-piece reusable tri-clamp style connector assembly that includes a means for holding the fitting in a stationary position while the nut is being tightened, that allows a user to accurately determine when the nut is sufficiently tightened onto the fitting, and that doesn't require factory installation in order to achieve a high pressure seal, and for a kit that includes the improved three-piece reusable tri-clamp style connector assembly and a tightening tool that is not cumbersome and will not mar the surface of the fitting.

### SUMMARY OF THE INVENTION

The present invention is reusable fitting, connector assembly and kit that overcome the drawbacks inherent in the prior art.

In its most basic form, the reusable fitting includes a barb portion, a threaded portion, a tightening portion, a connector portion and a substantially smooth cylindrical bore extending through the barb portion, threaded portion, tightening portion and connector portion. The barb portion includes a securing barb and is dimensioned to be inserted within an inside surface of the hose. The threaded portion includes a top surface from which the barb portion extends, a threaded radial surface that includes a plurality of threads, and a bottom surface. The top surface of the threaded portion has a flat portion extending circumferentially about the barb portion and a radial groove extending circumferentially about the flat portion. The tightening portion is disposed proximate to the bottom surface of the threaded portion and includes least two parallel tightening surfaces. The connector portion is disposed proximate to the tightening portion and includes at least one part of a connector for connecting the fitting to a piping system.

In the preferred embodiment of the fitting, the connector portion induces a neck and connector for connecting the fitting to a piping system is a tri-clamp flange. In these embodiments, the tightening portion includes two parallel tightening surfaces and extends from the bottom surface of the threaded portion. Finally, the preferred fitting is manufactured of a material, such as stainless steel, that is sterilizable.

In its most basic form, the three-piece reusable connector assembly includes the basic embodiment of the fitting, a nut and a crimp sleeve.

The crimp sleeve includes a substantially cylindrical body having an outer surface, an inner surface, a top and a bottom. The body includes a plurality of slits extending downward from the top of the body, a plurality of fingers defined by the slits, and a base portion defined by a termination of the slits about the body and the bottom of the body. The body of the crimp sleeve is dimensioned for disposal about the outside surface of the hose wherein the base portion is dimensioned for disposal within the radial groove in the top surface of the threaded portion of the fitting.

The nut includes an outer surface that includes at least two parallel tightening surfaces dimensioned to accommodate a wrench and an inner surface that includes a threaded portion and a tapered portion. The threaded portion includes a plurality of threads dimensioned to mate with the threads of the threaded radial surface of the fitting and a bottom edge. The tapered portion includes a first end having a first diameter, a second end having a second diameter that is larger than the first diameter, and a substantially conical surface defined by the first end and the second end.

In the preferred embodiment of the connector assembly, the connector portion of the fitting induces a neck and connector for connecting the fitting to a piping system. The connector is preferably a tri-clamp flange dimensioned to mate with another tri-clamp flange and be secured thereto by a conventional tri-clamp. In these embodiments, the tightening portion of the fitting extends from the bottom surface of the threaded portion and includes two parallel tightening surfaces. In the preferred connector assembly, the fitting, nut and crimp sleeve are each dimensioned such that the hose is properly connected to the connector assembly when the bottom edge of the nut is parallel to the bottom surface of the tightening portion of the fitting. The preferred fitting, nut and crimp sleeve are each manufactured of a material that is sterilizable, with the fitting preferably manufactured of stainless steel and the nut and crimp sleeve being manufactured of a plastic material.

In its most basic form the kit of parts of the present invention includes the basic embodiment of the connector assembly and at least one wrench. The wrench has at least one substantially flat surface and includes at least two parallel tightening surfaces disposed perpendicular from the substantially flat surface and dimensioned to mate with the tightening surfaces of the tightening portion of the fitting. The kit is adapted for assembly by disposing the hose through the nut and the crimp sleeve, disposing the base portion of the crimp sleeve within the radial groove in the top surface of the threaded portion of the fitting, mating the threads of the threaded portion of the nut is with the threads of the threaded portion of the fitting, disposing the wrench upon the fitting such that the substantially flat surface is in contact with the bottom surface of the treaded portion and the tightening surfaces of the wrench are mated with the tightening surfaces of the fitting, and tightening the nut onto the fitting until the bottom edge of the nut contacts the substantially flat surface of the wrench.

The preferred embodiment of the kit includes the preferred connector assembly and two wrenches; a fitting wrench and a nut wrench. The preferred fitting wrench has at least one substantially flat surface and at least two parallel tightening surfaces disposed perpendicular from the substantially flat surface and dimensioned to mate with the at least two tightening surfaces of the tightening portion of the fitting. The preferred nut wrench has at least one substantially flat surface and comprises at least two parallel tightening surfaces disposed perpendicular from the substantially flat surface and dimensioned to mate with the at least two tightening surfaces of the tightening portion of the fitting. Finally, it is preferred that the fitting wrench and the nut wrench each have a handle that includes a plurality of bores therethrough.

Therefore, it is an aspect of the invention to provide an improved three-piece reusable tri-clamp style connector assembly that includes a means for holding the fitting in a stationary position while the nut is being tightened.

It is a further aspect of the invention to provide an improved three-piece reusable tri-clamp style connector assembly that allows a user to accurately determine when the nut is sufficiently tightened onto the fitting.

It is a further aspect of the invention to provide an improved three-piece reusable tri-clamp style connector assembly that doesn't require factory installation in order to achieve a high-pressure seal

It is a further aspect of the invention to provide an improved three-piece reusable tri-clamp style connector assembly kit that includes the improved three-piece reusable tri-clamp style connector assembly and a tightening tool that is not cumbersome and will not mar the surface of the fitting.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is an assembly view of the prior art three-piece reusable sanitary tri-clamp style connector assembly.

FIG. 2 is sectional view of the prior art three-piece reusable sanitary tri-clamp style connector assembly of FIG. 1 cut along line A-A.

FIG. 3A is a side assembly view of the prior art three-piece reusable sanitary tri-clamp style connector assembly of FIG. 1 in a fully unassembled state.

FIG. 3B is a side assembly view of the prior art three-piece reusable sanitary tri-clamp style connector assembly of FIG. 1 with the hose and crimp sleeve mounted to the fitting and the nut fully unengaged.

FIG. 3C is a side assembly view of the prior art three-piece reusable sanitary tri-clamp style connector assembly of FIG. 1 with the hose and crimp sleeve mounted to the fitting and the nut partially engaged.

FIG. 3D is a side assembly view of the prior art three-piece reusable sanitary tri-clamp style connector assembly of FIG. 1 with the hose and crimp sleeve mounted to the fitting and the nut fully engaged.

FIG. 4 is an assembly view of the preferred three-piece reusable sanitary connector assembly of the present invention.

FIG. 5A is a side assembly view of the prior art three-piece reusable sanitary tri-clamp style connector assembly of FIG. 1 in a fully unassembled state.

FIG. 5B is a side assembly view of the prior art three-piece reusable sanitary tri-clamp style connector assembly of FIG. 1 with the hose and crimp sleeve mounted to the fitting and the nut fully unengaged.

FIG. 5C is a side assembly view of the prior art three-piece reusable sanitary tri-clamp style connector assembly of FIG. 1 with the hose and crimp sleeve mounted to the fitting and the nut partially engaged.

FIG. 5D is a side assembly view of the prior art three-piece reusable sanitary tri-clamp style connector assembly of FIG. 1 with the hose and crimp sleeve mounted to the fitting and the nut fully engaged.

FIG. 6A is a top view of a nut wrench the forms a part of the preferred kit of the present invention.

FIGS. 6B is a side view of the nut wrench of FIG. 6A.

FIG. 7A is a top view of a fitting wrench the forms a part of the preferred kit of the present invention.

FIGS. 7B is a side view of the nut wrench of FIG. 7A.

FIG. 8 is an isometric assembly view of kit of the present invention with one wrench engaging the nut and another wrench engaging the fitting.

### DETAILED DESCRIPTION OF THE INVENTION

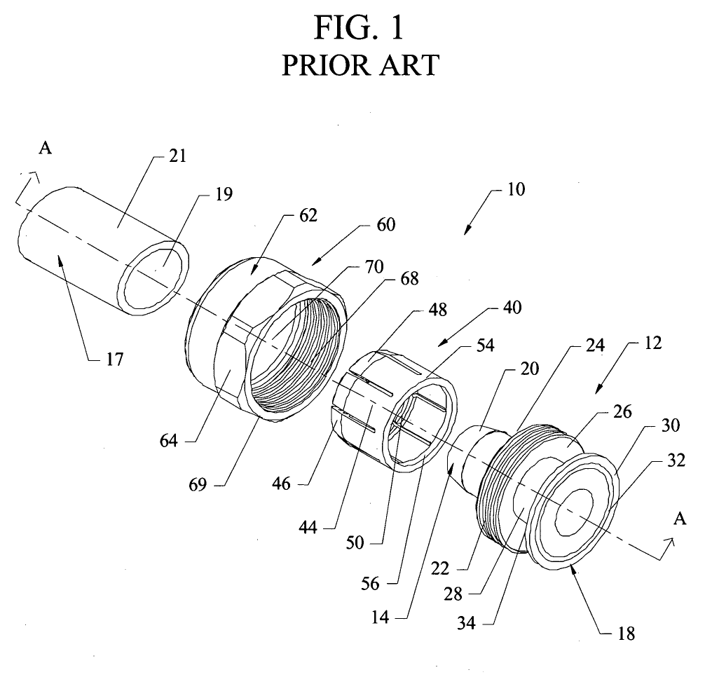

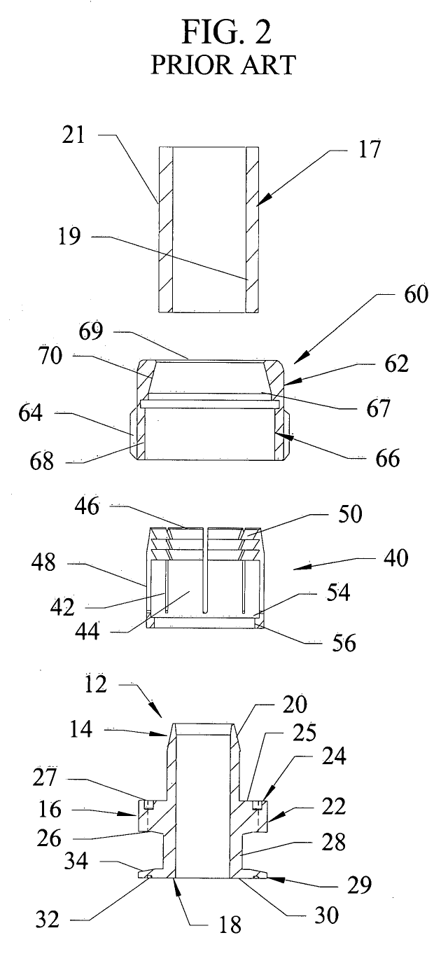

FIGS. 1-3 shows a conventional three-piece reusable sanitary tri-clamp style connector assembly 10. This connector assembly 10 includes a fitting 12, a crimp sleeve 40, and a nut 60, which are assembled together to form a removable termination for a hose 17 or tube.

Looking first to the fitting 12, the fitting 12 has a barb portion 14, a threaded portion 16, and a connector portion 18. The barb portion 14 is dimensioned to be inserted within the hose 17 and includes a securing barb 20 that grips the inside surface 19 of the hose 17 when the assembly 10 is assembled and prevents extraction of the hose 17 from the fitting 12. The threaded portion 16 has a larger diameter than the barb portion 14 and includes a threaded radial surface 22, a top surface 24, and a bottom surface 26. The top surface 24 includes a flat portion 25 having a width substantially equal to the thickness of the hose 17 and a radial groove 27 dimensioned to accept the crimp sleeve 40. The connector portion 18 includes a substantially smooth neck 28 that extends downward from the bottom surface 26 of the threaded portion 16 and terminates in a connector, such as the conventional tri-clamp flange 29 dimensioned to be connected to a matting flange via a tri-clamp (not shown). The tri-clamp flange 29 includes a flat bottom surface 30 having a radial groove 32 therein dimensioned to accept an O-ring (not shown) and a beveled top surface 34. Conventional fittings 12 are typically manufactured of stainless steel, but may also be manufactured of titanium or other materials that are steriliable and not prone to corrosion.

The second piece of the three-piece connector assembly 10 is the crimp sleeve 40. The crimp sleeve 40 is substantially cylindrical in shape and includes an outer surface 48, an inner surface 52 and a plurality of slits 42 that define a plurality of fingers 44. The top portions 46 of each of the fingers 44 are a tapered on the outer surface 48 and include a plurality of barbs 50 on the inner surface 52. The tapered outer surfaces 48 of the top portions 46 are dimensioned to mate with a tapered portion 70 of the inner surface 66 of nut 60, while the barbs 50 are dimensioned to grip the outside surface 21 of the hose 17. The slits 42 are included to allow the fingers 44 to flex inward when the nut 60 is tightened. The slits 42 all terminate at substantially the same location radially about the crimp sleeve 40, forming a base portion 54 thereof. The inner surface 52 of the base portion 54 is dimensioned to fit around the outside surface of the hose 17 or tube and preferably includes a radial lip 56 that extends inward from the inside surface 52 and serves as a stop for the hose 17 when it is inserted therein. The base portion 54 fits within groove 27 in the top surface 24 of the threaded portion 16 of the fitting 12. The crimp sleeve 40 is manufactured of a resilient material, preferably Delrin® brand plastic manufactured by the E.I. duPont de Nemours Company of Wilmington, Del., that flexes inward when the nut 60 is tightened and springs outward when the nut 60 is loosened. However, other sterilizable materials, such as stainless steel or polyvinylidene difluoride may also be used.

The nut 60 includes an outer surface 62 that includes a plurality of flat tightening surfaces 64 dimensioned to accommodate a wrench, and an inner surface 66 that includes a threaded portion 68 and a tapered portion 70. The threaded portion 68 includes a plurality of threads that are dimensioned to mate with the threads on the threaded radial surface 22 of the fitting 12. The tapered portion 70 has a substantially conical surface with the end 67 proximate to the threaded portion 68 having a diameter that is greater than the diameter of the end 69 of the tapered portion. The tapered portion 70 is dimensioned to mate with the tapered outer surfaces 48 of the top portions 46 of the fingers 44 of the crimp sleeve 40 such that the tightening of the nut 60 causes the tapered outer surfaces 48 of the top portions 46 of the fingers 44 to slide along the tapered portion 70, effectively forcing the fingers 44 inward against the hose 17. The nut 60 is typically manufactured of the same plastic material as the crimp sleeve 40, but may be manufactured of the same material as the fitting 12, or of a different sterilizable material, such as such as polyvinylidene difluoride.

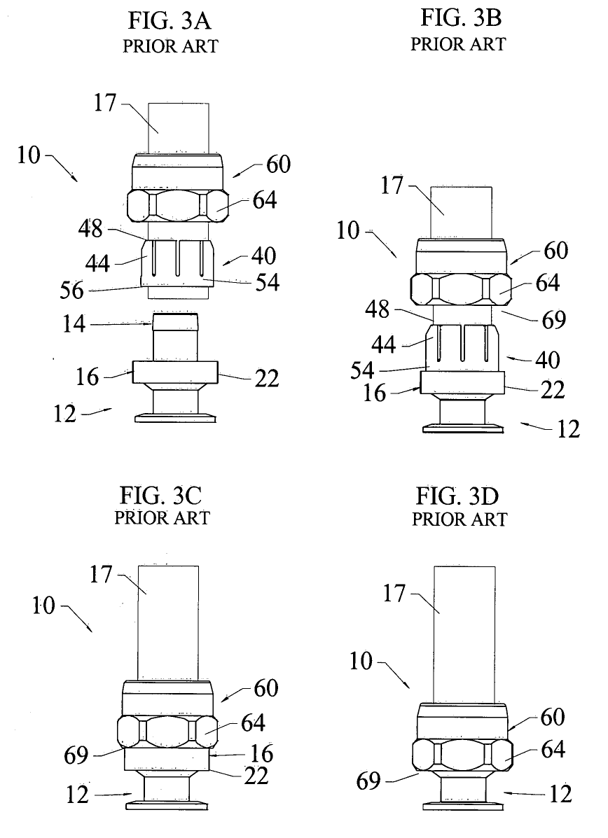

The connector assembly 10 is attached to the hose 17 in the manner shown in FIGS. 3A-3D. The hose 17 is preferably a reinforced silicone hose or a silicone tube, such as those commonly used in the pharmaceutical and good industries, but the assembly is adapted to work with any flexible hose or tube. As shown in FIG. 3A, the hose 17 is cut to length, the nut 60 is slid onto the hose 17 with the threaded portion 68 facing the cut end of the hose 17, and the crimp sleeve 40 is slid onto the hose 17 so that the end of the hose 17 is just below the radial lip 56 of the base portion 54 of the crimp sleeve 40. As shown in FIG. 3B, the barb portion 14 of the fitting 12 is then inserted into the cut end of the hose 17 until the barb portion is at its maximum depth and the base portion 54 of the crimp sleeve 40 rests inside the groove in the top surface 24 of the threaded portion 16 of the fitting 16. As shown in FIG. 3C, the nut 60 is then threaded onto the threaded portion 16 of the fitting 12 and tightened. As the nut 60 is advanced, the tapered portion 70 of the inside surface 66 of the nut 60 bears upon the tapered outer surfaces 48 of the top portions 46 of the fingers 44 of the crimp sleeve 40, causing the tapered outer surfaces 48 of the top portions 46 of the fingers 44 to slide along the tapered portion 70. This effectively forces the fingers 44 inward such that the barbs 50 on the inner surface 52 of the top portion 46 of the fingers to barbs 50 contact the outside surface of the hose 17. FIG. 3D shows the nut 60 fully tightened, which causes the hose 17 to be compressed between the barbs 50 on the crimp sleeves 40 and the barb portion 14 of the fitting 12. This compression creates a seal, which, when coupled with the attachment of the nut to the fitting, effectively joins the hose 17 to the fitting 14.

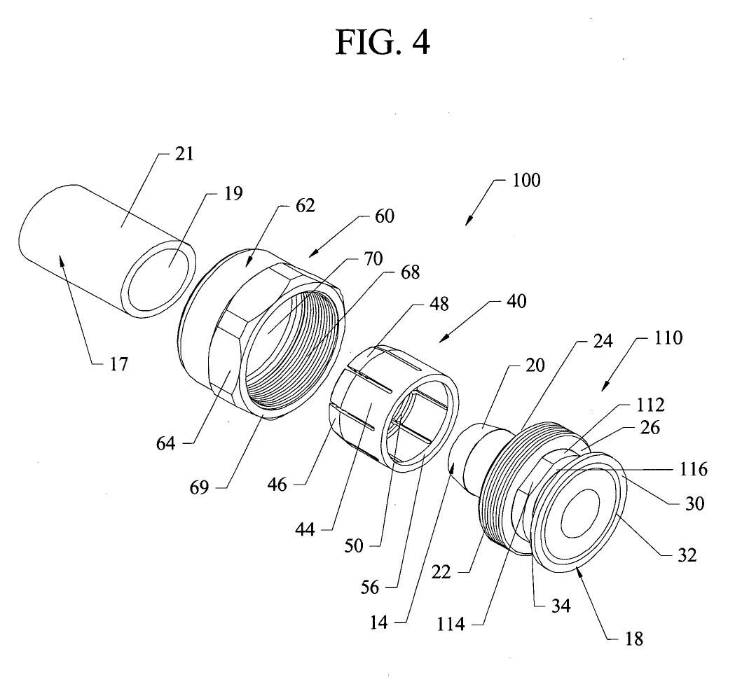

Referring now to FIG. 4, the improved three-piece reusable sanitary tri-clamp style connector assembly 100 of the present invention is shown. The nut 60 and crimp sleeve 40 of the improved connector assembly 100 of the present invention are identical in all respects to the nut 60 and crimp sleeve 40 of the prior art connector assembly 10 described above with reference to FIGS. 1-3. However, the fitting 110 of the improved connector assembly 100 has been modified in order to overcome the drawbacks inherent in conventional three-piece reusable sanitary tri-clamp style connector assemblies.

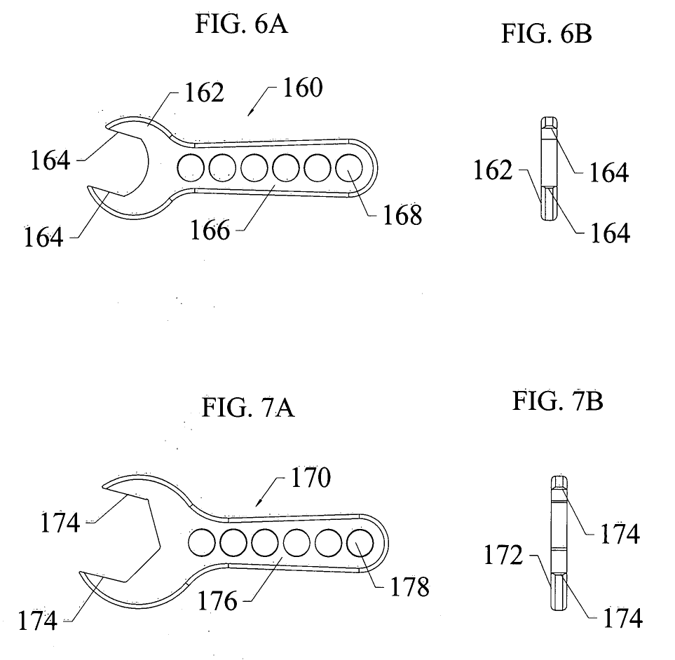

Referring to FIG. 4, the fitting 110 of the improved connector assembly 100 includes a tightening portion 112 having at least two parallel tightening surfaces 114. These tightening surfaces 114 are preferably dimensioned to accommodate a wrench, such as those shown in FIGS. 6 and 7, and allow the fitting 110 to be held in a stationary position during tightening without the need for cumbersome tools that mar the surfaces of the fitting 110. The preferred fitting 110 includes two parallel tightening surfaces 114. However, other embodiments may have four, six, eight or ten tightening surfaces 114, provided each tightening surface 114 is disposed parallel to another tightening surface 114.

In the embodiment of FIG. 4, the tightening portion 112 extends from the bottom surface 26 of the threaded portion 16, and the substantially smooth neck 28 extends downward from the bottom surface 116 of the tightening portion 112 rather than from the bottom surface 26 of the threaded portion 16. As discussed in detail below in connection with the kit 200 of the present invention, the disposition of the tightening portion 112 extending from the bottom surface 26 of the threaded portion 16 is preferred as it allows the wrench used to tighten the nut 60 to provide an affirmative stop, which alerts the installer to the fact that the nut 60 has been properly tightened. However, in other embodiments, the tightening portion 112 may be disposed in other locations proximate to the bottom surface 26 of the threaded portion 16 of the fitting 110.

The threaded portion 16 of the fitting 110 of the improved connector assembly 100 is similar to that of the conventional fittings 14 insofar as it includes a plurality of threads that are dimensioned to mate with the nut 60. However, the threaded portion 16 of the improved fitting is dimensioned such that the installer knows when the nut 60 has been properly tightened. In the preferred fitting 110, this is accomplished by including a number of threads sufficient for proper tightening when the nut 60 is advanced such that no threads are visible. The proper number of threads will vary depending upon the angles of the tapers on the tapered outer surfaces 48 of the top portions 46 of the fingers 44 of the crimp sleeve 40 and the tapered portion 70 of the nut, and depending upon the thickness of the hose 17 and tubing to be used. Thus, the size of the fitting 110, nut 60 and crimp sleeve 40 vary based upon the type of hose 17 to which the fitting 110 is connected, such that are each dimensioned such that the hose 17 is properly connected to the connector assembly 100 when the bottom edge 69 of the nut is parallel to the bottom surface 26 of the threaded portion 16 of the fitting 110.

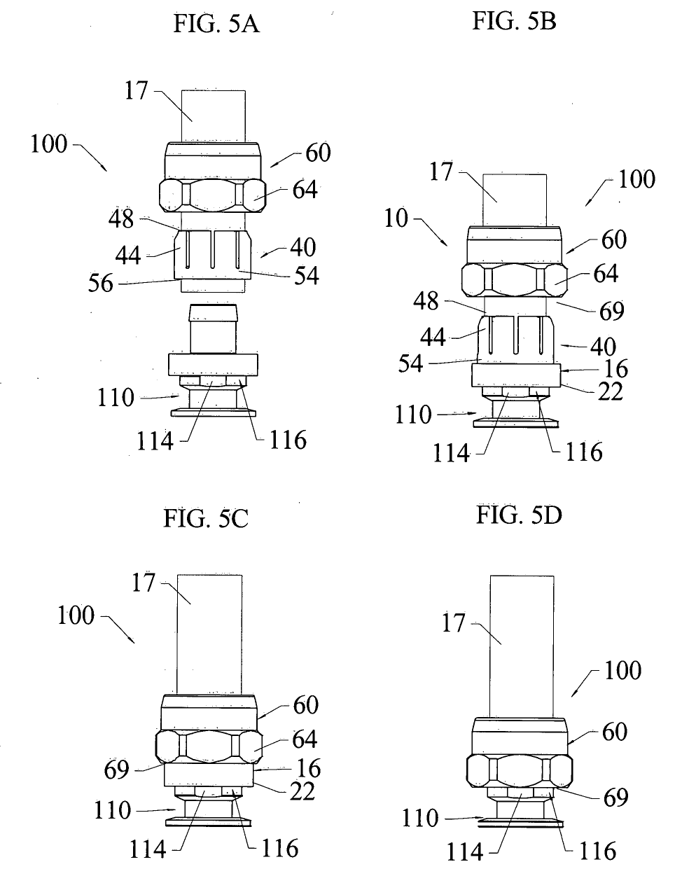

As shown in FIGS. 5A-5D, the connector assembly 100 of the present invention is assembled in substantially the same manner as described above with reference to FIGS. 3A-3D. As shown in FIG. 5A, the hose 17 is cut to length, the nut 60 is slid onto the hose 17 with the threaded portion 68 facing the cut end of the hose 17, and the crimp sleeve 40 is slid onto the hose 17 so that the end of the hose 17 is just below the radial lip 56 of the base portion 54 of the crimp sleeve 40. As shown in FIG. SB, the barb portion 14 of the fitting 110 is then inserted into the cut end of the hose 17 until the barb portion is at its maximum depth and the base portion 54 of the crimp sleeve 40 rests inside the groove in the top surface 24 of the threaded portion 16 of the fitting 16. As shown in FIG. 5C, the nut 60 is then threaded onto the threaded portion 16 of the fitting 110 and tightened. However, unlike the prior art assembly 10, the nut 60 is tightened only until the bottom edge 69 of the nut is parallel to the bottom surface 26 of the threaded portion 16 of the fitting 110 FIG. 5D shows the nut 60 in this fully tightened position.

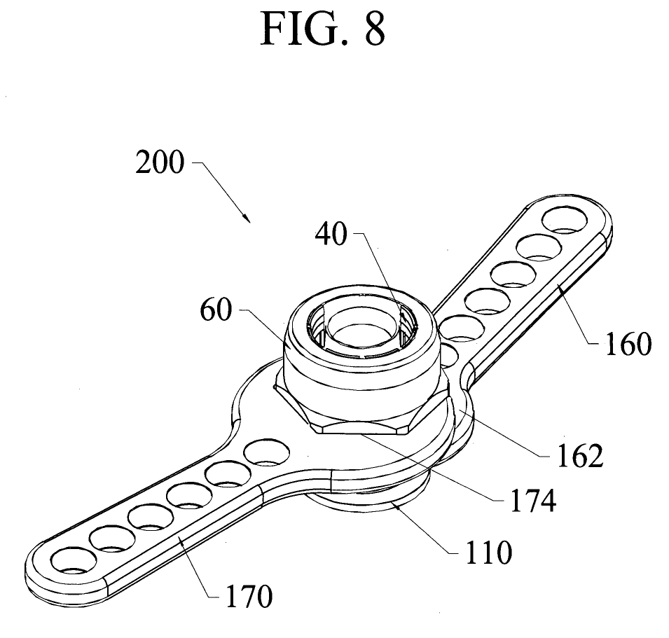

The kit of the present invention includes the connector assembly 110 of FIGS. 4 and 5, and at least one wrench. FIGS. 6A-7B show fitting wrenches 160, 170 that form part of the kit. FIGS. 6A and 6B show the fitting wrench 160, which is included in all embodiments of the kit. The fitting wrench 160 has at least one substantially flat surface 162 and at least two parallel tightening surfaces 164 disposed perpendicular from the flat surface 162. The tightening surfaces 164 are disposed apart a distance dimensioned to mate with the tightening surfaces 114 of the tightening portion 112 of the fitting 112. As explained below in connection with FIG. 8, the flat surface 162 is included in order to provide an affirmative stop for the travel of the nut 60 when the flat surface 162 is disposed against the bottom surface 26 of the threaded portion 16 of the fitting 110.

The preferred kit also includes the nut wrench 170 shown in FIGS. 7A and 7B. The nut wrench 170 also has at least one substantially flat surface 172 and at least two parallel tightening surfaces 174 disposed perpendicular from the flat surface 172. The tightening surfaces 174 are disposed apart a distance dimensioned to mate with the tightening surfaces 68 of the tightening portion 64 of the nut 60. It is preferred that both the fitting wrench 160 and nut wrench 170 each include a handle 166, 176 that includes a plurality of bores 168, 178 therethrough. The bores 168, 178 are intended to lower the overall weight of the wrenches 160,170. In the preferred embodiment, manufacturing them from a lightweight material, such as aluminum, further reduces the weight of the wrenches 160, 170. However, other embodiments of the wrenches 160, 170 may not have the bores 168, 178 and/or be manufactured of higher weight materials, such as steel.

Referring now to FIG. 8, the kit 200 of the present invention is shown in connection with the assembly of the connector assembly 100. The hose has been omitted from this drawing for purposes of clarity, but it should be understood that the hose would be inserted in the location shown in connection with FIGS. 5A-5D.

As shown in FIG. 8, the kit 200 is adapted for attaching the connector assembly 110 to the hose by disposing the hose through the nut 60 and the crimp sleeve 40, disposing the base portion (not shown) of the crimp sleeve 40 within the radial groove (not shown) in the top surface (not shown) of the threaded portion (not shown) of the fitting 112 and mating the threads (not shown) of the threaded portion (not shown) of the nut 60 with the threads (not shown) of the threaded portion (not shown) of the fitting 112. The fitting wrench 160 is then disposed upon the fitting 112 such that the substantially flat surface 162 is in contact with the bottom surface (not shown) of the treaded portion (not shown) and the tightening surfaces of the fitting wrench 160 are mated with the tightening surfaces (not shown)of the fitting 112. The nut wrench 170 is then disposed upon the nut 60 such that the tightening surfaces 174 of the nut wrench 170 engage the tightening surfaces 64 of the nut 60. The wrenches 160, 170 are then used to tighten the nut 60 onto the fitting 112 until the bottom edge (not shown) of the nut 60 contacts the flat surface 162 of the fitting wrench 160.

Although the present invention has been described in considerable detail with reference to certain preferred versions thereof, other versions would be readily apparent to those 17 of ordinary skill in the art. Therefore, the spirit and scope of the appended claims should not be limited to the description of the preferred versions contained herein.

What is claimed is:

1. A reusable fitting for attachment to a hose having an outside surface and an inside surface, said fitting comprising
a barb portion dimensioned to be inserted within the inside surface of the hose, said barb portion comprising a securing barb;
a threaded portion comprising a top surface from which said barb portion extends, a threaded radial surface comprising a plurality of threads, and a bottom surface, wherein said top surface comprises a flat portion extending circumferentially about said barb portion and a radial groove extending circumferentially about said flat portion;
a tightening portion disposed proximate to said bottom surface of said threaded portion, said tightening portion comprising at least two parallel tightening surfaces;
a connector portion disposed proximate to said tightening portion, said connector portion comprising at least one part of a connector for connecting said fitting to a piping system; and
a substantially smooth cylindrical bore extending through said barb portion, said threaded portion, said tightening portion and said connector portion.

2. The fitting as claimed in claim 1 wherein connector portion further comprises a neck and wherein said at least one part of connector for connecting said fitting to a piping system comprises a flange.

3. The fitting as claimed in claim 2 wherein said flange comprises a tri-clamp flange.

4. The fitting as claimed in claim 1 wherein said tightening portion comprises two parallel tightening surfaces.

5. The fitting as claimed in claim 4 wherein said tightening portion extends from said bottom surface of said threaded portion

6. The fitting as claimed in claim 1 wherein said fitting is manufactured of a material that is sterilizable.

7. A three-piece reusable connector assembly for attachment to a hose having an outside surface and an inside surface, said connector assembly comprising:
a fitting comprising:
a barb portion dimensioned to be inserted within the inside surface of the hose, said barb portion comprising a securing barb;
a threaded portion comprising a top surface from which said barb portion extends, a threaded radial surface comprising a plurality of threads, and a bottom surface, wherein said top surface comprises a flat portion extending circumferentially about said barb portion and a radial groove extending circumferentially about said flat portion;
a tightening portion disposed proximate to said threaded portion, said tightening portion comprising at least two parallel tightening surfaces;
a connector portion disposed proximate to said tightening portion, said connector portion comprising at least one part of a connector for connecting said fitting to a piping system; and
a substantially smooth cylindrical bore extending through said barb portion, said threaded portion, said tightening portion and said connector portion;
a crimp sleeve comprising:
a substantially cylindrical body comprising an outer surface, an inner surface, a top and a bottom, said body comprising a plurality of slits extending downward from said top of said body, a plurality of fingers defined by said slits, and a base portion defined by a termination of said slits about said body and said bottom of said body;
wherein said body of said crimp sleeve is dimensioned for disposal about the outside surface of the hose; and
wherein said base portion of said crimp sleeve is dimensioned for disposal within said radial groove in said top surface of said threaded portion of said fitting; and
a nut comprising:
an outer surface comprising at least two parallel tightening surfaces; and
an inner surface comprising a threaded portion and a tapered portion;
wherein said threaded portion comprises a bottom edge and a plurality of threads dimensioned to mate with said threads of said threaded radial surface of said fitting; and
wherein said tapered portion comprises first end having a first diameter, a second end having a second diameter that is larger than said first diameter, and a substantially conical surface defined by said first end and said second end.

8. The connector assembly as claimed in claim 7 wherein connector portion of said fitting further comprises a neck and wherein said at least one part of connector for connecting said fitting to a piping system comprises a flange.

9. The connector assembly as claimed in claim 8 wherein said flange comprises a tri-clamp flange.

10. The connector assembly as claimed in claim 9 wherein said tightening portion of said fitting comprises two parallel tightening surfaces.

11. The connector assembly as claimed in claim 10 wherein said tightening portion of said fitting extends from said bottom surface of said threaded portion.

12. The connector assembly as claimed in claim 10 wherein said fitting, said nut and said crimp sleeve are each dimensioned such that the hose is properly connected to said connector assembly when said bottom edge of said nut is parallel to said bottom surface of said threaded portion of said fitting.

13. The connector assembly as claimed in claim 7 wherein said fitting, said nut and said crimp sleeve are each manufactured of a material that is sterilizable.

14. The connector assembly as claimed in claim 13 wherein said fitting is manufactured of a stainless steel material and wherein said nut and said crimp sleeve are each manufactured a plastic material.

15. A kit of parts comprising:
a three-piece reusable connector assembly for attachment to a hose having an outside surface and an inside surface, said connector assembly comprising:
a fitting comprising:
a barb portion dimensioned to be inserted within the inside surface of the hose, said barb portion comprising a securing barb;
a threaded portion comprising a top surface from which said barb portion extends, a threaded radial surface comprising a plurality of threads, and a bottom surface, wherein said top surface comprises a flat portion extending circumferentially about said barb portion and a radial groove extending circumferentially about said flat portion;
a tightening portion extending from said bottom surface of said threaded portion, said tightening portion comprising at least two parallel tightening surfaces;
a connector portion disposed proximate to said tightening portion, said connector portion comprising at least one part of a connector for connecting said fitting to a piping system; and
a substantially smooth cylindrical bore extending through said barb portion, said threaded portion, said tightening portion and said connector portion;
a crimp sleeve comprising:
a substantially cylindrical body comprising an outer surface an inner surface, a top and a bottom, said body comprising a plurality of slits extending downward from said top of said body, a plurality of fingers defined by said slits, and a base portion defined by a termination of said slits about said body and said bottom of said body;
wherein said body of said crimp sleeve is dimensioned for disposal about the outside surface of the hose; and
wherein said base portion of said crimp sleeve is dimensioned for disposal within said radial groove in said top surface of said threaded portion of said fitting; and
a nut comprising:
an outer surface comprising at least two parallel tightening surfaces; and
an inner surface comprising a threaded portion and a tapered portion;
wherein said threaded portion comprises a bottom edge and a plurality of threads dimensioned to mate with said threads of said threaded radial surface of said fitting; and
wherein said tapered portion comprises first end having a first diameter, a second end having a second diameter that is larger than said first diameter, and a substantially conical surface defined by said first end and said second end; and
at least one wrench, wherein said at least one wrench has at least one substantially flat surface and comprises at least two parallel tightening surfaces disposed perpendicular from said substantially flat surface and dimensioned to mate with said at least two tightening surfaces of said tightening portion of said fitting;
wherein said kit is adapted for attaching said connector assembly to the hose by disposing the hose through said nut and said crimp sleeve, disposing said base portion of said crimp sleeve within said radial groove in said top surface of said threaded portion of said fitting, mating said threads of said threaded portion of said nut with said threads of said threaded portion of said fitting, disposing said wrench upon said fitting such that said substantially flat surface is in contact with said bottom surface of said treaded portion and said tightening surfaces of said wrench are mated with said tightening surfaces of said fitting, and tightening said nut onto said fitting until said bottom edge of said nut contacts said substantially flat surface of said wrench.

16. The kit as claimed in claim 15 wherein said connector portion of said fitting further comprises a neck and wherein said at least one part of connector for connecting said fitting to a piping system comprises a tri-clamp flange.

17. The kit as claimed in claim 15 wherein said fitting, said nut and said crimp sleeve are each manufactured of a material that is sterilizable.

18. The kit as claimed in claim 17 wherein said fitting is manufactured of a stainless steel material and wherein said nut and said crimp sleeve are each manufactured a plastic material.

19. The kit as claimed in claim 15 wherein at least one wrench comprises a fitting wrench and a nut wrench;
wherein said fitting wrench has at least one substantially flat surface and comprises at least two parallel tightening surfaces disposed perpendicular from said substantially flat surface and dimensioned to mate with said at least two tightening surfaces of said tightening portion of said fitting; and
wherein said nut wrench comprises at least two parallel tightening surfaces dimensioned to mate with said at least two tightening surfaces of said tightening portion of said fitting.

20. The kit as claimed in claim 19 wherein said fitting wrench and said nut wrench each comprise a handle comprising a plurality of bores therethrough.
